(19) United States
(12) Patent Application Publication
(10) Pub. No.: US 2001/0048714 A1
(43) Pub. Date: Dec. 6, 2001

(54) Method and apparatus for processing a secondary synchronization channel in a spread spectrum system

(76) Inventor: Uma Jha, Placentia, CA (US)

Correspondence Address: PENNIE AND EDMONDS, 1155 AVENUE OF THE AMERICAS, NEW YORK, NY, 100362711

(21) Appl. No.: 09/772,583

(22) Filed: Jan. 29, 2001

Related U.S. Application Data
(60) Provisional application No. 60/178,830, filed on Jan. 28, 2000.

(51) Int. Cl. H04K 1/00; H04B 15/00; H04L 27/30

(52) U.S. Cl. 375/150; 375/343

(57) ABSTRACT

A method and apparatus for processing a secondary synchronization channel in a spread spectrum system is disclosed herein. The method includes several steps, the first of which is to receive a first input data at a correlator. Next, a first code sequence of a code group is received at the correlator. The first correlator then correlates the first input data with the first code sequence. Afterward, a second code sequence is received at the correlator. This time, the first input data is correlated with the second code sequence. Correlation of both the first code sequence and the second code sequence occurs prior to receiving a second input data. Lastly, correlation results from the first correlator are compared with a threshold value using a threshold detector.

This application claims priority to the provisional patent application with the following Ser. No.: 60/178,830 filed on Jan. 28, 2000.

### TECHNICAL FIELD

The present claimed invention relates to the field of wireless communication. In particular, the present claimed invention relates to an apparatus and a method for processing a synchronization channel in a spread spectrum communication system.

### BACKGROUND ART

Wireless communication has extensive applications in consumer and business markets. Among the many communication applications/systems are: fixed wireless, unlicensed (FCC) wireless, local area network (LAN), cordless telephony, personal base station, telemetry, mobile wireless, and other digital data processing applications. While each of these applications utilizes spread spectrum communications, they generally utilize unique and incompatible synchronization protocols. Synchronizing the timing between two devices is required in wireless spread spectrum devices in order to identify starting locations of data information, control information, etc. in a transmitted signal. Consequently, each application may require unique and incompatible hardware, software, and methodologies for synchronizing. This paradigm can be costly in terms of design, testing, manufacturing, and infrastructure resources across the diversified spread spectrum applications. As a result, a need arises to overcome the limitations associated with the varied hardware, software, and methodology of synchronizing digital signals for each of the varied spread spectrum applications.

Furthermore, new generations of protocols and hardware arise in many of the varied spread spectrum applications. These new generations can have sufficient differences from the previous generation so as to render legacy systems incompatible or unusable. This situation arises from the equipment that has been developed using a standard-centric perspective. Consequently, new software, hardware, or infrastructure may be required to accommodate a new synchronization code protocol in a given spread spectrum application. Again, this practice can be costly in terms of design, testing, manufacturing, and infrastructure resources. Consequently, a need arises to overcome the lack of backward and forward compatibility associated with new generations of synchronization protocols, hardware, and infrastructure within any of the varied wireless applications.

A searcher device can be utilized to perform a synchronization operation between a received signal and a known secondary code group. For example, one communication device can transmit synchronization sequences on a control channel to a second communication device that synchronizes the phase of the received sequence to an internally provided synchronization sequence. However, using a synchronization code group can include multiple possible sets of code sequences. The sets of code sequences are arranged in different orders to form code sequence groups, each of which can identify different communication devices. With multiple possible code sequence hypotheses to evaluate, a search operation can take a significant amount of time. However, many users and many spread spectrum applications have increasingly stringent performance standards. Consequently, a need arises for a method and apparatus to synchronize multiple code sequences with input data in a timely manner. Furthermore, integrated circuit resources such as available power and surface area are limited. Consequently, a need arises for hardware to synchronize the multiple code sequences with the input data while overcoming limitations of inefficient size and power-consumption.

### SUMMARY OF THE INVENTION

The present invention provides a solution to the limitations associated with the varied hardware, software, and methodology of synchronizing digital signals for each of the varied spread spectrum applications. Additionally, the present invention overcomes the lack of backward and forward compatibility associated with new generations of synchronization protocols, hardware, and infrastructure within any of the varied wireless applications. Furthermore, the present invention provides a method and apparatus to synchronize multiple code sequences with input data while overcoming the limitations of inefficient and slow hardware and algorithms.

In one embodiment, the present invention provides a method for processing a secondary synchronization channel in a spread spectrum system. The method include several steps, the first of which is to receive a first input data at a correlator. Next, a first code sequence of a code group is received at the correlator. The first correlator then correlates the first input data with the first code sequence. Afterward, a second code sequence is received at the correlator. This time, the first input data is correlated with the second code sequence. Correlation of both the first code sequence and the second code sequence occurs prior to receiving a second input data. Lastly, correlation results from the first correlator are compared with a threshold value using a threshold detector.

A second embodiment of the present invention provides a searcher for data processing. The searcher includes a first input line and a second input line coupled to a first correlator. Notably, the correlator can complete a correlation operation within a fraction of a slot period. The first input line is for communicating input data, while the second input line is for communicating a first set of code sequences. A first threshold detector, coupled to the first correlator, indicates whether the correlation result exceeds a threshold value.

These and other objects and advantages of the present invention will become apparent to those of ordinary skill in the art after having read the following detailed description of the preferred embodiments, which are also illustrated in the various drawing figures.

### BRIEF DESCRIPTION OF THE DRAWINGS

The drawings included herewith are incorporated in and form a part of this specification. The drawings illustrate embodiments of the invention and, together with the description, serve to explain the principles of the invention. It should be understood that the drawings referred to in this description are not drawn to scale unless specifically noted as such.

FIG. 1 is a block diagram of an electronic communication device having a configurable secondary synchronization channel searcher, in accordance with one embodiment of the present invention.

FIG. 2A is a block diagram of a configurable secondary synchronization channel searcher system, in accordance with one embodiment of the present invention.

FIG. 2B is a block diagram of a configurable secondary synchronization channel searcher, in accordance with one embodiment of the present invention.

FIG. 2C is an alternative block diagram of a configurable secondary synchronization channel searcher, in accordance with one embodiment of the present invention.

FIG. 3 is a block diagram of a correlator circuit, in accordance with one embodiment of the present invention.

FIG. 4A is a timing diagram of a primary synchronization channel and a secondary synchronization channel used in a spread spectrum communication system, in accordance with one embodiment of the present invention.

FIG. 4B is a table of code groups having secondary synchronization sequences used in a spread spectrum communication system, in accordance with one embodiment of the present invention.

FIG. 5 is a functional block diagram of inputs and outputs for a correlator configuration determination, in accordance with one embodiment of the present invention.

FIG. 6A is a flowchart of a process for configuring a configurable secondary synchronization channel searcher, in accordance with one embodiment of the present invention.

FIG. 6B is a flowchart of a process for operating a configurable secondary synchronization channel searcher, in accordance with one embodiment of the present invention.

### DETAILED DESCRIPTION OF THE INVENTION

Reference will now be made in detail to the preferred embodiments of the invention. Examples of the preferred embodiment are illustrated in the accompanying drawings. While the invention will be described in conjunction with the preferred embodiments, it is understood that they are not intended to limit the invention to these embodiments. Rather, the invention is intended to cover alternatives, modifications and equivalents, which may be included within the spirit and scope of the invention, as defined by the appended claims. Additionally, in the following detailed description of the present invention, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the present invention.

The present invention can be implemented in a wide variety of digital spread spectrum wireless communication systems or techniques that utilize code sequences. Code sequences are utilized in wireless communications for many functions including, but not limited to: searching, spreading, scrambling, despreading, and descrambling The systems or techniques which utilize code sequences include, but are not limited to, fixed wireless, unlicensed Federal Communications Commission (FCC) wireless systems, wireless local area network (W-LAN), cordless telephony, cellular telephony, personal base station, telemetry, and other digital data processing applications. The present invention can be applied to both transmitters, e.g., a base station, and to receivers, e.g., a terminal, for wired and wireless cellular telephony, and personal base station applications.

In particular, one fixed wireless application to which the present invention may be applied is a metropolitan multipoint distribution system (MMDS). Examples include wireless cable broadcast, or two-way wireless local loop (WLL) systems. Some examples of a W-LAN that can communicate digitized audio and data packets, for which the present invention can be applied include Open Air, and the Institute of Electrical and Electronics Engineers (IEEE) specification 802.11 b. In yet another application, specific examples of unlicensed FCC applications to which the present invention may be applied include the Industrial, Scientific, and Medical band (ISM) devices, which can include cordless telephony products. Wireless cellular base stations can utilize either cordless or cellular telephony wireless communication standards. Lastly, the cellular telephony systems in which the present invention can be applied include, but are not limited to, IS-95, IS2000, ARIB, 3GPP-FDD, 3GPP-TDD, 3GPP2, 1EXTREME, or other user-defined protocols. The range of code-sequences utilized in the exemplary spread spectrum applications disclosed herein, are useful to define the class of functions for which the present configurable code generator unit is applicable.

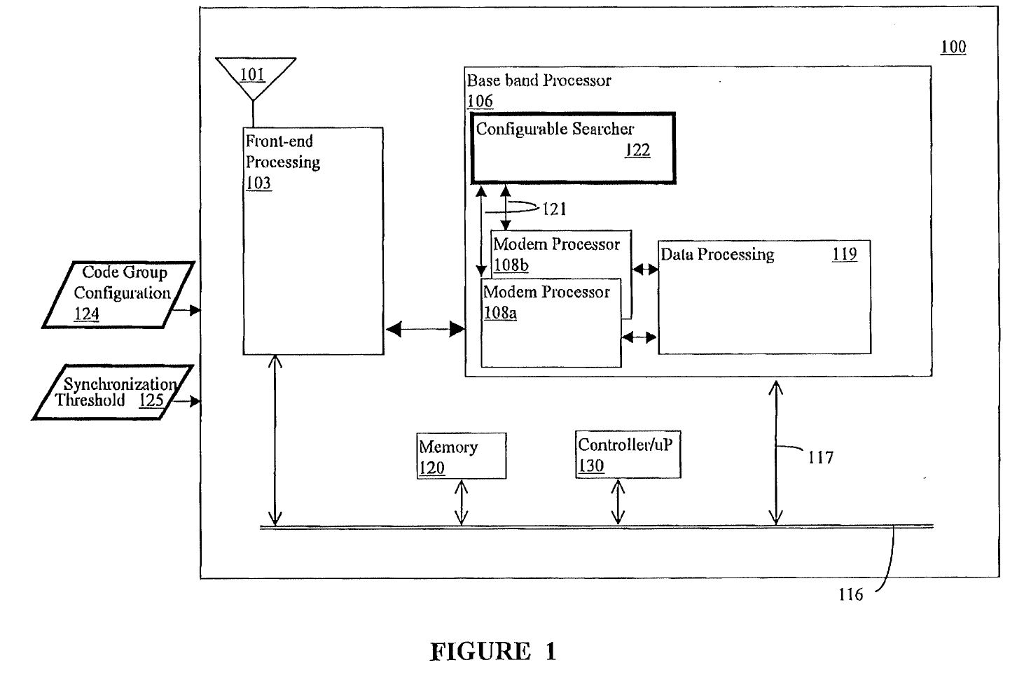

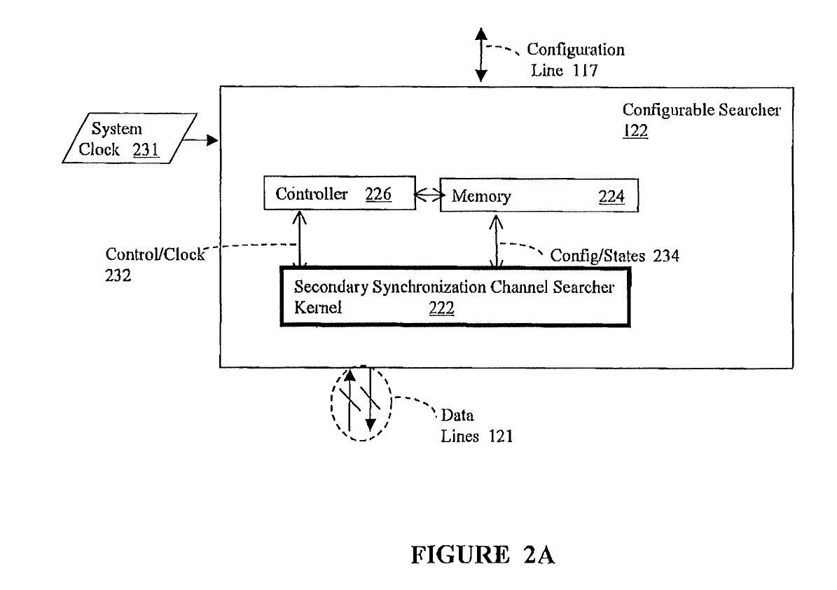

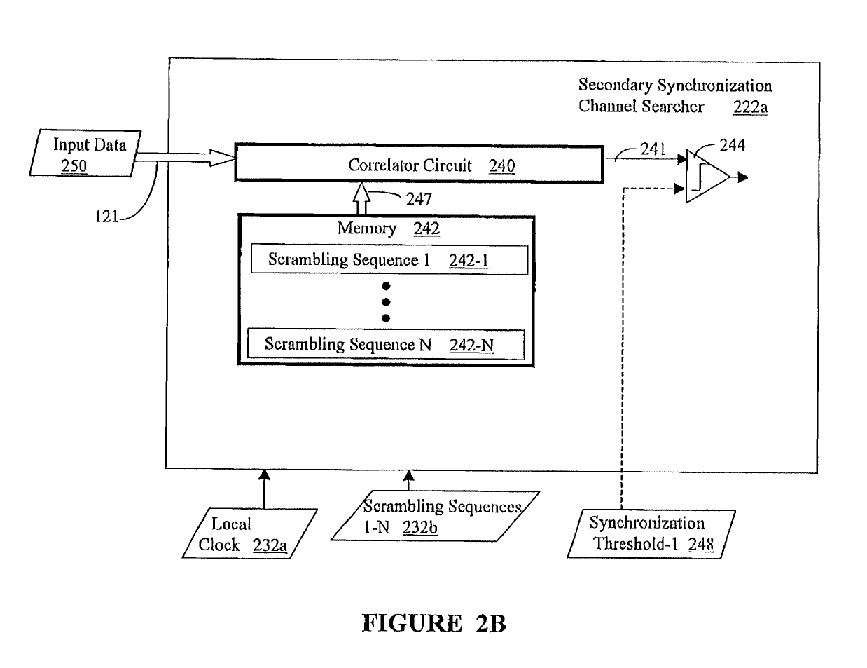

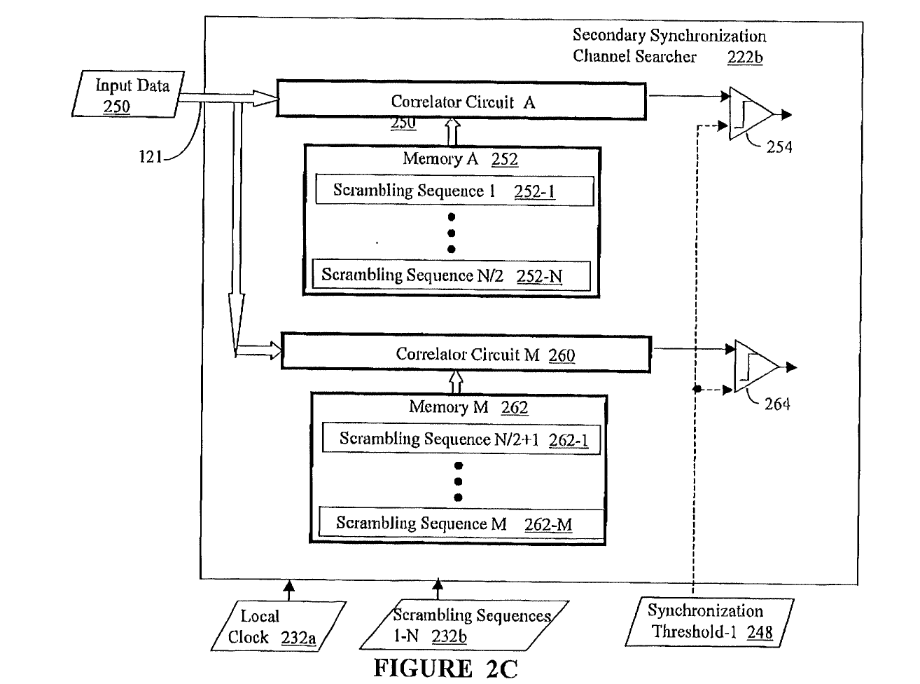

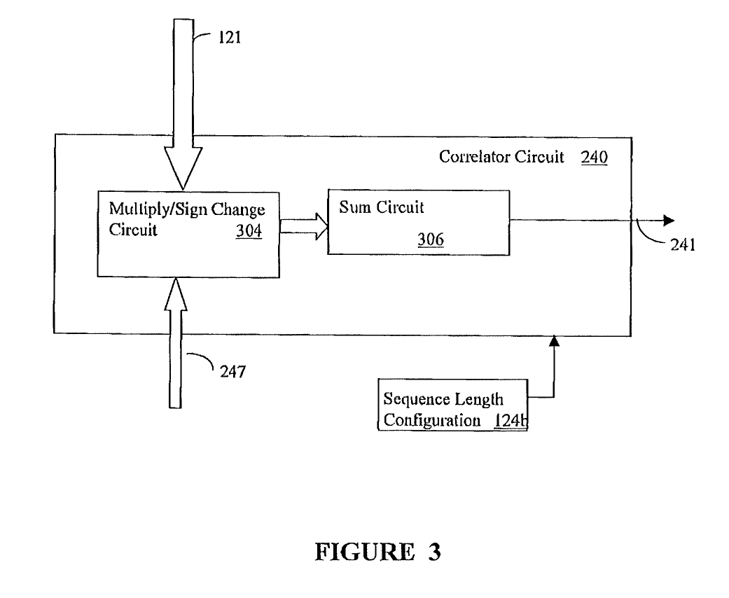

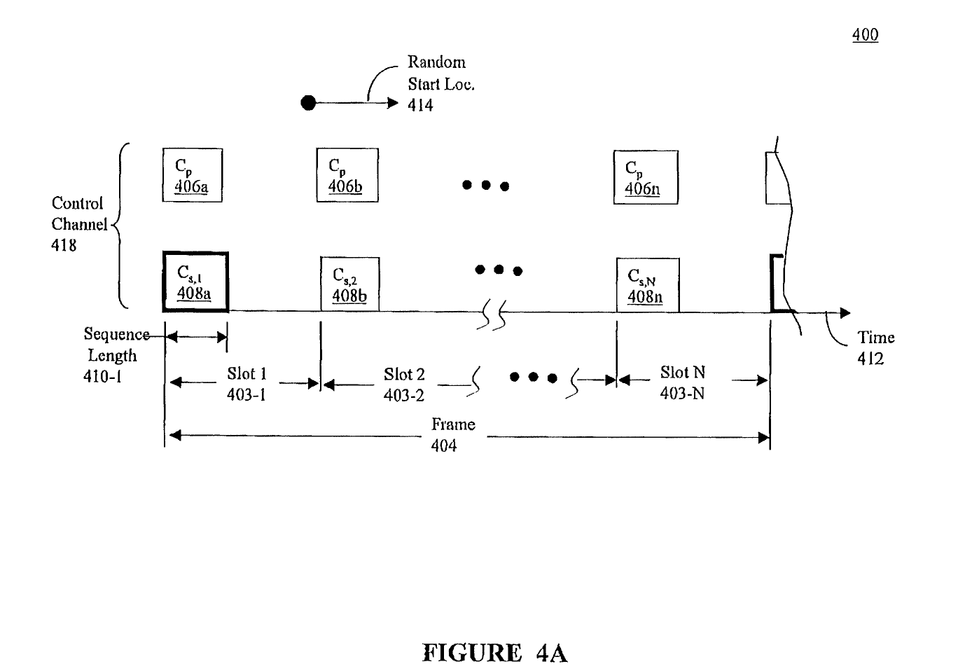

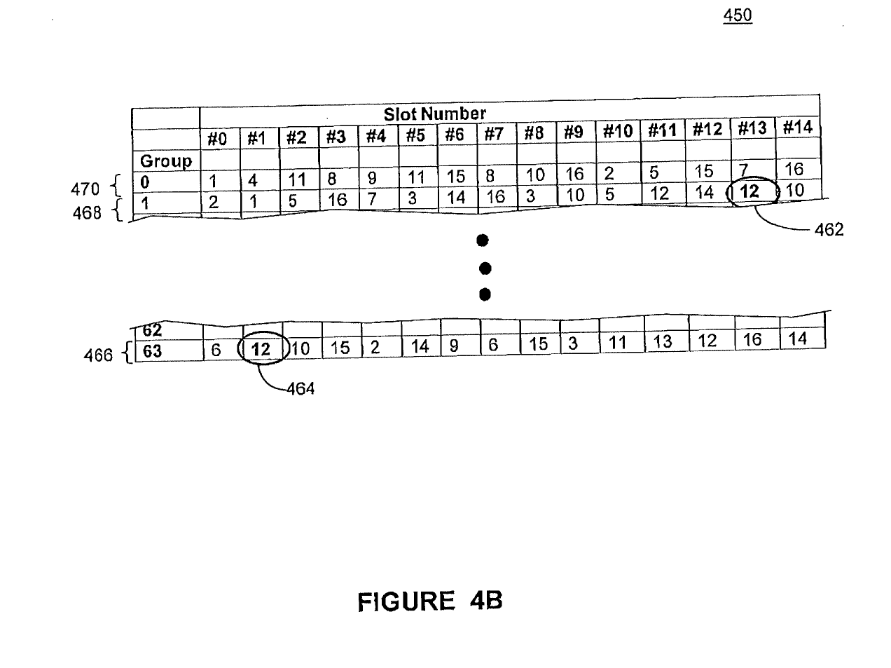

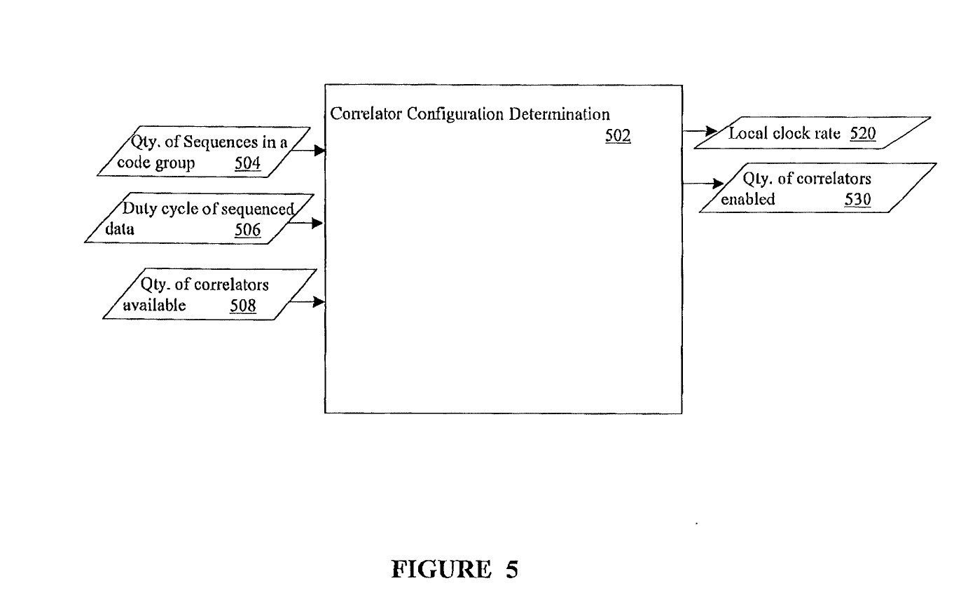

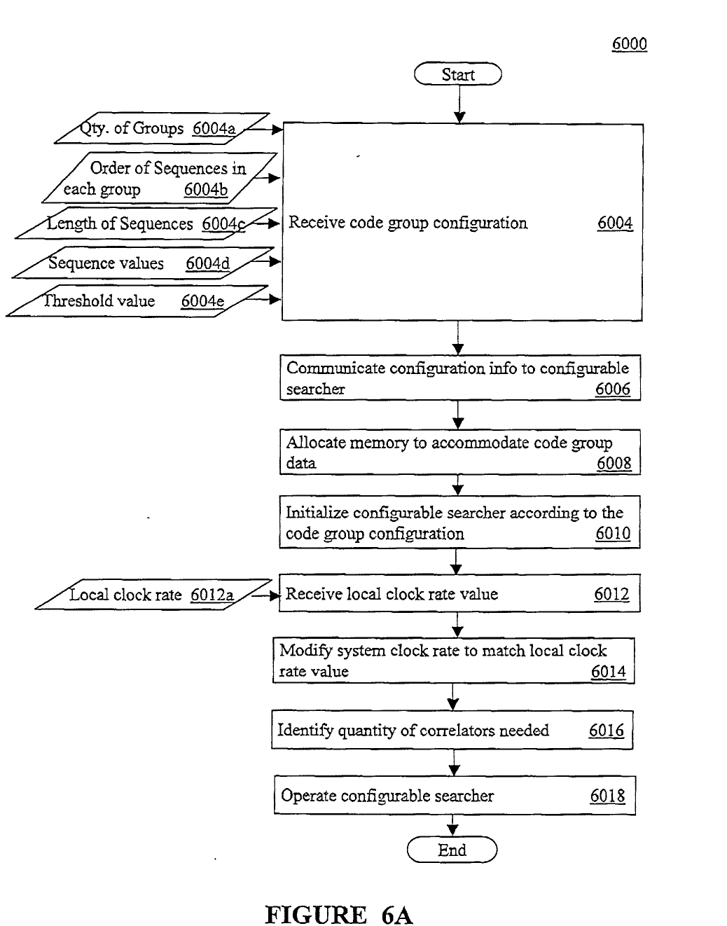

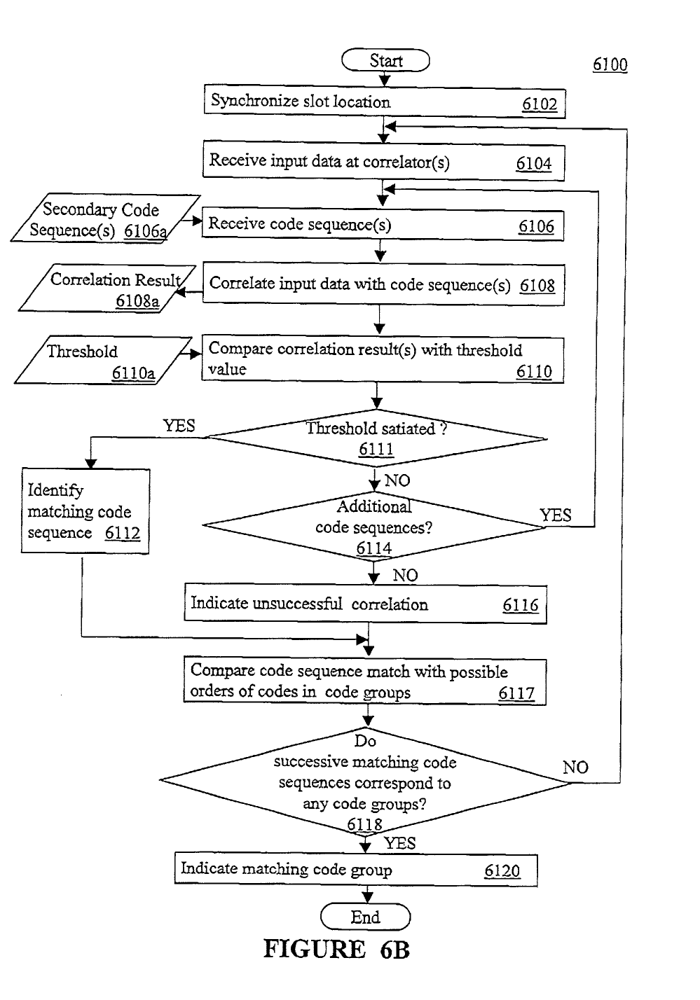

The detailed description of the present invention begins with a description of a spread-spectrum communication device, in FIG. 1, in which a configurable secondary synchronization searcher is implemented. Then, subsequent FIGS. 2A-2C and FIG. 3 will provide a detailed description of the configurable secondary synchronization searcher itself. Thereafter, a timing diagram in FIG. 4 depicts a primary synchronization code and a secondary synchronization code. A function block diagram in FIG. 5 shows input values that are evaluated in determining the correlation circuit configuration of the configurable secondary synchronization searcher. Lastly, various processes associated with the communication device and the configurable secondary synchronization searcher are described in FIGS. 6A-6B.

### Communication Device

Referring now to FIG. 1, a block diagram of an electronic communication device having a configurable secondary synchronization channel searcher is shown, in accordance with one embodiment of the present invention. Electronic communication device 100 provides an exemplary application of the present invention in a wireless spread spectrum wideband code division multiple access (WCDMA) base station. Furthermore, the present invention is applicable to any electronic device utilizing code sequences for data processing. The configurable searcher system 122 of the communication system 100 is described hereinafter in exemplary hardware and flowchart diagrams.

Communication device 100 includes an antenna 101, a front-end processing block 103, a base band processing block 106, a microprocessor (μP)/controller 130, a memory block 120, and a bus 116. Front-end processing block 103 is coupled to base band processing block 106, both of which are coupled to μP 130 and memory block 120 via bus 116. Microprocessor 130 and memory block 120 support the exchange of data, instructions, and/or configuration information to the various components of communication device 100. Base band processor block 106 is coupled to front-end processing block 103 to receive and to transmit signals therefrom.

Front-end processing block 103 is coupled to antenna 101 to receive a wireless signal. Front-end processing block 103 includes components (not shown) such as a radio frequency (RF) transceiver and an analog to digital (A/D) converter, coupled to each other in series. Subcomponents and functions of front-end processing block 103 are known to those skilled in the art.

Base band processing block 106 is operable to process the wide band signal delivered by a source. In the present embodiment, base band processing block 106 includes multiple modem processors 108a and 108b coupled to configurable searcher 122 via lines 121. Configurable searcher 122 utilizes a code group configuration dictated by a desired one of a plurality of communication protocols. Base band processing block also includes data processing block 119 coupled to modem processors 108a and 108b. Data processing block 119 performs functions such as combining, decoding, etc., that are performed by a combiner, a codec device, and other components known by those skilled in the art. These components are not shown in data processing block 119 for purposes of clarity.

Communication device 100 is operable to receive inputs for configuring the configurable channel searcher 122. As an example, the present embodiment receives an input of code group configuration 124 and an input of synchronization threshold 125, whose functions are described in a subsequent flowchart. Configuration input 124 can provide for secondary synchronization operations suitable for a given spread spectrum application. For example, configuration input 124 can provide secondary synchronization operations for a CDMA system using a 3GPP protocol. Code group configuration information includes, but is not limited to: 1) a quantity of sequences in a group; 2) a length of each of the sequences; and 3) a quantity of groups for secondary synchronization.

Configuration inputs 124 and 125 to communication device 100 can be designed using a computing device with a graphical user interface (GUI) and a library of functions that provide predetermined configuration options, in one embodiment. Additionally, communication device 100 can receive the desired code generator configuration input 124 and synchronization threshold input 125 via a variety of embodiments. For example, in one embodiment, configuration information is received via wired communications with a computing device, e.g., a host/external processor/workstation. In another embodiment, configuration information can be provided by an electronic storage medium, e.g., CD-ROM. In yet another embodiment, configuration information is received by wireless transmission from another communication device, e.g., a wireless test platform, via antenna 101.

In another aspect, configuration information is provided at the time communication device 100 is manufactured and/or initially programmed for operation in the field, in the present embodiment. However, in another embodiment, configuration information is dynamically implemented at a time communication device 100 is in operation in the field. Configuration information is received, processed, and implemented via controller 130 and memory 120, which then communicate the information and instructions via line 117 to base band processor 106 for implementation in configurable searcher 122.

Configurable searcher 122 is a hardware computation resource that can be applied to a single computation process, e.g., a multipath of a given channel, in one embodiment. However, in another embodiment, the computation resource provided by configurable searcher 122 can be enhanced by running configurable searcher 122 at a clock rate higher than that required by a process, e.g., higher than the data rate for a communication protocol. In this manner, resources of individual computation components, such as configurable searcher 122, can be time-shared across multiple computation processes, e.g., several multipaths and/or multiple channels. Additional information on the design and implementation of configurations into a configurable communication device is provided in co-pending U.S. patent application Ser. No. 09/492,634 entitled “IMPROVED APPARATUS AND METHOD FOR MULTI-THREADED SIGNAL PROCESSING” by Ravi Subramanian et al., attorney docket number MORP-P002. This related application is commonly assigned, and is hereby incorporated by reference.

While communication device 100 provides a specific quantity of components that are arranged in a specific configuration, the present invention is well suited to a wide range of alternatives. For example, while two modem processors 108a and 108b are shown in base band processor 106, the present invention is well suited to having only a single modem processor. Additionally, communication device 100 is adaptable to many spread spectrum systems and is capable of implementing a wide range of communication protocols, as described hereinafter. While the present embodiment utilizes a configurable searcher 122, the present invention is well suited to using a static configuration of the searcher shown in FIGS. 2B and 2C.

### Secondary Synchronization Channel Searcher

Referring now to FIG. 2A, a block diagram of a configurable secondary synchronization channel searcher system is shown, in accordance with one embodiment of the present invention. Configurable secondary synchronization channel searcher 122 includes a local controller 226, a secondary synchronization channel (or group code) searcher kernel 222, and a memory block 224 in the present embodiment. Group code searcher kernel 222 is a satellite kernel, which is algorithmic-specific in the present embodiment. That is, while group code searcher kernel 222 is a configurable electronic device capable of performing a wide range of algorithms, the algorithms are limited to a class of searcher functions. In another embodiment, the class of searcher functions is for secondary synchronization searcher functions. An exemplary description of a group code searcher kernel 222 is described in subsequent FIGS. 2B and 2C. A satellite kernel has a local controller and memory that allows it to operate autonomously, e.g., like a satellite, from system control, thus reducing overhead and traffic on the overall system.

Input/output data lines 121 are coupled to configurable searcher 122 to provide data transfer, in the present embodiment. In particular, input/output data lines 121 provide data streams to and from modem processors 108a and 108b of communication device 100 of FIG. 1. Local controller 226 provides control functions to configurable searcher kernel 222 to enable data transfer with minimal input from a global controller, e.g., controller 130 of FIG. 1. The communication mechanism between each kernel is dataflow driven in the present embodiment. Controller 226 is a state machine with memory, in the present embodiment, capable of controlling configurable searcher kernel 222. In one embodiment, controller 226 includes memory that is capable of preserving state conditions of at least one configuration of searcher kernel 222. Controller 226 controls implementation of configuration information to, and operation of, searcher kernel 222 in the present embodiment. Configuration information is received at controller 226 and memory 224 via configuration line 117. Thus, configurable searcher 122 uses a distributed control and configuration via local controller 226, which effectively reduces overhead in terms of instruction fetch and global control.

Additionally, configurable searcher 122 receives system clock input 231. In one embodiment local controller 226 scales system clock input 231 to a desired local clock rate for configurable searcher kernel 222. Local clock scaling allows operation of configurable kernel 222 at higher rates than the system clock. This allows for time-sliced architecture discussed hereinabove (in referenced U.S. patent application Ser. No. 09/492,634) and hereinafter in a flowchart description.

Control/clock line 232 provides scaled clock signals, and provides control signals to, and receives status signals from, configurable searcher kernel 222.

Memory block 224 is random access memory (RAM), register file, or combination thereof, for storing data, instructions, states, and/or configuration information for controller 226 and/or configurable searcher kernel 222, in the present embodiment. Memory block 224 is coupled to receive and/or store configuration information, e.g., despreader mode 112 and despreader observation length 114 of FIG. 1, via configuration line 117. Memory block 224 includes both static registers, which are fixed at initialization, and dynamic registers, which can be updated internally and on the fly by other components within a communication device, e.g., local controller 226. Memory 224 passes configuration and state information to configurable searcher kernel 222 via interconnect 234.

By having local memory block 224 and local controller 226, configurable searcher 122 is an autonomous device in the present embodiment. This arrangement provides a very quick and efficient changing of configuration data for algorithmic satellite kernel, or searcher kernel, 222. Therefore, time-sharing of a hardware kernel is feasible and practical.

Configurable searcher 122 of FIG. 2A is well suited to alternative embodiments. For example, a system controller can provide control functions to configurable searcher kernel 222, thus eliminating local controller 226. In another alternative, memory block 224 can be any form of memory, such as registers, flash memory, etc.

Referring now to FIG. 2B, a block diagram of a configurable secondary synchronization channel searcher is shown, in accordance with one embodiment of the present invention. FIG. 2B provides an exemplary embodiment of secondary synchronization channel searcher 222a for application in configurable searcher block 122 of FIG. 2A and in communication device 100 of FIG. 1.

Secondary synchronization channel searcher 222a includes a correlation circuit 240 and a memory 242, coupled to each other via line 247. Secondary synchronization channel searcher 222a also includes a threshold detector 244, coupled to correlator circuit 240 via line 241. Threshold detector 244 is any device that can compare two signals and provide an output when one input meets and/or exceeds the other. A digital comparator circuit is used as a threshold detector in the present embodiment. Components in secondary channel searcher 222a are multi-bit wide in the present embodiment to allow communication and processing of multiple bits in parallel. Thus, line 247 and 121 provide multi-bit long data and scrambling sequences in parallel for simultaneous processing in correlator circuit 240. The present embodiment provides sufficient bit-width devices to accommodate the requirements of the various spread spectrum applications mentioned hereinabove. Thus, for example, lines 121 and 247 are 16 bits wide to accommodate existing applications in one embodiment, and 32 bits wide to accommodate future increases in another embodiment. An exemplary correlator circuit is provided in subsequent FIG. 3.

Input data 250 is communicated to correlator circuit 240 via antennae 101, front-end processing block 103, modem processor 108a and lastly line 121, as shown in FIG. 1. Input data 250 refers to the synchronization data communicated on a synchronization channel as a complex value. Local clock input 232a from local controller 226 of FIG. 2A is provided to components in secondary synchronization channel searcher 222a for synchronization purposes. In this manner, the processing rate of components in secondary synchronization channel searcher 222a can be scaled up or down from a system clock rate to accommodate processing needs of a range of applications. Scrambling sequences 1 through N are provided as input 232b and stored in memory 242. Scrambling sequences can be provided as an external input, e.g., code group configuration 124 to communication device 100 of FIG. 1. Alternatively, scrambling sequences can be internally generated using a code generator or an algorithm executed by uP 130 and memory A20. Lastly, synchronization threshold 1 248 is provided to secondary synchronization channel searcher 222a and communicated to threshold detector 244. Synchronization threshold input 125 of FIG. 1 can be stored in memory 224 of FIG. 2A or in memory 242 of FIG. 2B.

Memory 242 has a quantity of individual memories e.g., 242-1 through 242-N for storing a series of scrambling sequences. In the present embodiment, memory 242 has sufficient resources to accommodate a quantity of scrambling sequences than exceeds the requirements of the various spread spectrum applications mentioned hereinabove. Additionally, memory 242 has sufficient resources to accommodate a scrambling sequence length that exceeds the requirements of the various spread spectrum applications. In this manner, the present invention can accommodate future changes in spread spectrum systems that fall within the memory allotments in the present embodiment. Memory 242 can be any type of memory device capable of storing a state, e.g., flip-flop registers, flash random access memory (RAM), etc.

Referring now to FIG. 2C, an alternative block diagram configuration of a configurable secondary synchronization channel searcher is shown, in accordance with one embodiment of the present invention. FIG. 2C provides an alternative secondary synchronization channel searcher 222b to that described in FIG. 2B, for application in configurable searcher 122 of FIG. 2A. Secondary synchronization channel searcher 222b has many components and coupling arrangements that are similar to those presented in secondary synchronization channel searcher 222a of FIG. 2B. For purposes of clarity, only a description of subcomponents, coupling arrangements, and alternatives for FIG. 2C that are different from FIG. 2B will be provided.

Secondary synchronization channel searcher provides multiple searcher components coupled in parallel to simultaneously search/correlate data faster. Specifically, secondary synchronization channel searcher 222b includes multiple correlator circuits, e.g., circuit A 250 and circuit M 260, multiple memories, e.g., memory A 252 and memory M 262, and multiple threshold detectors 254 and 264. In the present embodiment, the quantity of multiple components used is two (M=2). Memory A 252 and threshold detector 254 are coupled to circuit A 250 while memory M 262 and threshold detector 264 are coupled to circuit M 260.

Notably, memory A 252 and memory M 262 contain only a portion of the quantity of scrambling sequences needed for a given spread spectrum protocol. Thus, memory A 252 has scrambling sequence 1 252-1 through scrambling sequence N/2 252-N while memory M 262 has scrambling sequence N/2+1 262-1 to scrambling sequence M 262-M. In this embodiment, the scrambling sequences are evenly divided between the memories.

Input data 250 is communicated to correlator circuits 1 250 and circuit M 260 in parallel via line 121. Synchronization threshold 1 248 is communicated to both threshold detectors 254 and 264 in parallel where it will evaluate correlation results from correlator circuit A 250 and circuit M 260 in parallel.

Secondary synchronization channel searcher 222b is well suited to a wide range of alternatives to those described in the present embodiment. For example, any quantity of parallel correlator/memory/threshold detector components can be utilized. In one embodiment, the quantity of parallel correlator/memory components exceeds that required for any of the various spread spectrum applications mentioned hereinabove to accommodate future increases in scrambling sequences. Additionally, only one threshold detector can be used in one embodiment to evaluate results from multiple correlator circuits. Threshold detector can serially evaluate results from correlator circuits, e.g., using a buffer to store some of the inputs. In this manner, hardware resources are conserved, and performance is substantially maintained, e.g., comparison operations occur over cycles where correlator circuit is busy. Additionally, scrambling sequences can be divided in a wide range of formats between multiple memories. In another embodiment, secondary synchronization channel searcher 222b can be provided as a static design for a single spread spectrum application of communication device 100. While the present embodiment utilizes multi-bit wide lines and operations, the present invention is well suited to using single bit wide components and operations.

Referring now to FIG. 3, a block diagram of a correlator circuit is shown, in accordance with one embodiment of the present invention. FIG. 3 provides an exemplary embodiment of correlator circuit 240 for application in secondary synchronization channel searcher 222a of FIG. 2B. Correlator circuit 240 includes a complex multiply/sign change circuit 304 coupled to a sum circuit 306. Multiply circuit 304 is coupled to line 121 to receive input data and to line 247 to receive a scrambling sequence.

Multiply circuit 304 and sum circuit 306 are multi-bit wide devices in the present embodiment. That is, multiply circuit 304 includes a bank of multiplication logic components that are individually and parallely coupled to a respective memory location for a scrambling sequence value and a respective portion of the input line bus 121 for an input data value. Multiply circuit 304 has a sufficient bank of multiply-logic components in the present embodiment to accommodate the greatest requirements of the multiple spread spectrum applications mentioned hereinabove. Thus, for example, multiply circuit 304 includes 16 multiply logic devices in one embodiment to accommodate existing applications. In another embodiment, multiply circuit 304 and sum circuit 306 have sufficient components to accommodate future spread spectrum applications that may utilize longer sequences, e.g., devices 304 and 306 can accommodate 32 bit wide inputs.

Because correlator circuit 240 is configurable, it receives configuration information 124b provided via communication device components described in FIG. 1. In one embodiment, configuration information 124b includes sum width, e.g., scrambling sequence length, for sum circuit 306. Thus, if all of the multiply-logic components in multiply circuit 304 are not needed for a given spread spectrum application, then sum circuit 306 should not include them in the sum operation. A selective interconnect, e.g., an AND gate, can disable inputs from multiply circuit so as to effectuate the correct quantity of input values. For example, if multiply circuit 304 includes 19 multiply-logic components, but a secondary scrambling sequence length of only 16 bits is used for a given spread spectrum application, then a three-bit adder portion of sum circuit 306 can be disabled via sequence length configuration input 124b. Thus, correlator circuit 240 enables a configurable searcher 122 in communication device 100 that can accommodate a wide variety of spread spectrum applications. In another embodiment, correlator circuit 240 has fixed circuitry for fixed input data lengths.

Referring now to FIG. 4A, a timing diagram of a primary synchronization channel and a secondary synchronization channel used in a spread spectrum communication system is shown, in accordance with one embodiment of the present invention. Timing diagram 400 provides a snapshot of a timing sequence portion of a control channel provided to a communication device using an exemplary cellular spread spectrum telephony protocol. Timing diagram 400 is useful for applying the subsequent methods of flowchart 6000 and 6100 to hardware FIGS. 1 through 3.

Timing diagram 400 provides timing sequence portions of a control channel, e.g., a synchronization channel (SCH), used to establish synchronization and subsequently negotiate service between two communication devices, e.g., a mobile handset and a base station. Control channel 418 includes a primary synchronization sequence, Cₚ, and a secondary synchronization sequence, Cₛ, that occur at periodic intervals over time 412. In particular, a single Cₚ, e.g., Cₚ 406a, and a single Cₛ, e.g., 408a, occur for a given slot, e.g., slot 1 403-1. The Cₚ sequence defines the beginning of each slot and is the same for every slot. Thus, Cₚ 401a through Cₚ 406n are the same sequence for slot 1 403-1 through slot N 403-N, respectively. In contrast, the secondary sequences are used to identify the beginning location of a frame, which comprises multiple slots. Hence, secondary sequences are different for each slot for a given period of slots known as a frame, e.g., frame 404. Thus, sequences Cₛ , 1 408a through C_{S,N} 408n are all different sequences for slots 1 403-1 through slot N 403-N, and will repeat for every frame. In the present embodiment, the frame length is defined as having fifteen slots, e.g., N=15. Primary synchronization sequence Cₚ 406b corresponds to secondary synchronization sequence C_{s,2} 408b for slot 2 403-2.

Notably, Cₚ and Cₛ have a sequence length 410-1, which is 256 chips long in the present embodiment. With a slot length of 2560 chips, e.g., for slot 1 403-1, synchronization sequences only occupies 1/10^{th} of each slot, leaving the last 9/10^{ths} of the slot idle in terms of receiving synchronization data. This idle time can be used to process the data, e.g., from Cₛ, 1 408a, before the next sequence arrives, e.g., sequence Cₛ , 2 408b. The entire frame 404 consumes 10 milliseconds (ms) for the exemplary protocol.

A random start location 414 is shown in FIG. 4A. When one communication device is powered up, it receives a control channel signal at some unknown phase. Random start location 414 provides an exemplary start location that will be utilized in the following flowchart to illustrate the acquisition of the secondary synchronization code sequence.

Referring now to FIG. 4B, a table of code groups having secondary synchronization sequences used in a spread spectrum communication system is shown, in accordance with one embodiment of the present invention. Code group table 450 provides an exemplary table used in a cellular spread spectrum application.

Code group table 450 has multiple rows of code groups, e.g., group 0 470, code group 1 468, through code group 63 466. Each code group has a unique sequence of code sequences. Sixteen unique code sequences, e.g., code sequence 1 through code sequence 16, each having 256 chips. A communication device will transmit on a control channel 418 of FIG. 4A, using a given code group, e.g., code group 63. Other communication devices will use other code groups, and thus avoid interfering with each other. The application code group table 450 will be described more fully in subsequent flowcharts.

Referring now to FIG. 5, a functional block diagram of inputs and outputs for a correlator configuration determination is shown, in accordance with one embodiment of the present invention. Correlator configuration determination block 502 receives inputs indicating correlation resources available and correlation resources required for a given spread spectrum protocol. By evaluating these inputs, configuration determination block 502 can provide an output that allocates the correlation resources efficiently.

Input 508 provides an available resource in terms of quantity of correlators available. Inputs 504 and 506 describe the quantity of sequences in a code group while input 506 provides a duty cycle of sequence data. For example, FIG. 4A provides a sequence data input that has a 10% duty cycle, e.g., 256 chips long sequence out of a 2560 chip long input data block.

Outputs include a local clock rate 520 and a quantity of correlators enabled 530. Both outputs allocate resources of correlators by operating greater or fewer allocators at a higher or lower local clock rate. By doing so, the present invention enables the secondary synchronization sequence configurable searcher to accommodate the requirements for a wide range of spread spectrum systems. For example, the clock rate of one correlator circuit can be operated at M times a data rate to provide M times as many resources if there are insufficient quantity of correlator hardware resources. Correlation configuration determination block 502 can be implemented as a look up table (LUT) located in memory of a communication device, e.g., device 100, that provides suitable outputs for given input value combinations that were provided as configuration input, e.g., 124, as shown in FIG. 1. Alternatively, correlation configuration determination block 502 can be implemented on an external processor, with outputs 520 and 530 transferred to communication device 100 as a configuration input, e.g., 124, as shown in FIG. 1.

### Processes

Referring now to FIG. 6A, a flowchart of a process for configuring a configurable secondary synchronization channel searcher is shown, in accordance with one embodiment of the present invention. Flowchart 6000 is implemented, in the present embodiment, using exemplary diagrams of FIGS. 1 through 5. By using the present flowchart embodiment, the present invention provides a method of configuring the configurable searcher 122 and its components, e.g., correlator circuit 240. As a result, flowchart 6000 enables the present invention to accommodate a wide range of spread spectrum communication applications and protocols.

Flowchart 6000 begins with step 6004 in the present embodiment, in which a code group configuration input is received at a communication device. Step 6004 is implemented by receiving inputs 124 and 125 via antenna 101 and front-end processing block 103, which communicate the configuration input data to memory A20 and configurable searcher 122, as shown in FIG. 1. Configuration input values include but are not limited to: a quantity of groups of codes for input 6004a, an order of secondary synchronization sequences within each group for input 6004b, a chip length of secondary synchronization sequences for input 6004c, secondary synchronization sequence values for input 6004d, and a threshold value for threshold detector for input 6004e. Following step 6004, flowchart 6000 proceeds to step 6006.

In step 6006 of the present embodiment, the code group configuration is communicated to the configurable searcher. Step 6006 is implemented by communicating the configuration information via line 117 to the configurable searcher 122 as shown in FIGS. 1 and 2A. Once received, the configuration information can be stored in memory block 224 for implementation during initialization. Following step 6006, flowchart 6000 proceeds to step 6008. step 6008 of the present embodiment a sufficient memory is allocated to accommodate the quantity of code groups and the length of the sequences used in the code groups. Step 6008 is implemented by local or system controller 130 or 224 of FIGS. 1 or 2A allocating a sufficient amount of memory, e.g., memory 252 and memory M 262 of FIG. 2C, to accommodate the code group configuration. Following step 6008, flowchart 6000 proceeds to step 6010.

In step 6010 of the present embodiment the configurable searcher is initialized according to the code group configuration. Step 6010 is implemented in the present embodiment by communicating configuration information from local memory 224, or by system memory A20, as prompted by a local controller 226, or a system controller 130, respectively, to appropriate configurable components. For example, sum circuit 306, which a configurable component, can receive sequence length input 124b, as shown in FIG. 3, during initialization so that it is configured for the appropriate spread spectrum application. Following step 6010, flowchart 6000 proceeds to step 6012.

In step 6012 of the present embodiment a local clock rate input 6012a, at which the configurable searcher is to operate, is received. Step 6012 can be implemented by either receiving the local clock rate via code group configuration input 124, or by determining the local clock rate input by using information stored local to communication device, as describe in FIG. 5. Following step 6012, flowchart 6000 proceeds to step 6014.

In step 6014 of the present embodiment a system clock rate is modified to match the local clock rate value. Step 6014 is implemented in one embodiment by local controller 226 receiving a system clock input 231, then increasing or decreasing to match the local clock rate input. In this manner, the configurable searcher obtains substantial flexibility to scale its resources for a given spread spectrum application. Following step 6014, flowchart 6000 proceeds to step 6016.

In step 6016 of the present embodiment, a quantity of correlators necessary for accommodating a code group configuration is identified. Step 6016 is implemented by either receiving as input 124, the quantity of correlators to be implemented. Alternatively, the quantity of correlators to be implemented can be determined by system controller 130 and system memory A20, as described in FIG. 5. Following step 6016, flowchart 6000 proceeds to step 6018.

In step 6018 of the present embodiment the configurable searcher is operated according to the code group configuration. Subsequent flowchart 6100 provides an exemplary process for operating configurable searcher for secondary synchronization code. Following step 6018, flowchart 6000 ends.

Referring now to FIG. 6B, a flowchart of a process for operating a configurable secondary synchronization channel searcher is shown, in accordance with one embodiment of the present invention. Flowchart 6100 is implemented, in the present embodiment, using exemplary diagrams of FIGS. 1 through 5. By using the present flowchart embodiment, the present invention provides a method of operating configurable searcher 122 and its components, e.g., correlator circuit 240. As a result, flowchart 6100 enables the present invention to perform secondary synchronization quickly using an efficient quantity of hardware. A configurable searcher can be configured by exemplary flowchart 6000 prior to implementation of flowchart 6000. Alternatively, flowchart 6100 can be implemented on a static searcher configuration without using flowchart 6000.

Flowchart 6100 begins with step 6102 in the present embodiment, in which a primary synchronization slot location is determined. Step 6102 is implemented using hardware and methods known to one skilled in the art. As a result of step 6102, primary synchronization sequence positions, e.g., Cₚ 406a through Cₚ 406n of FIG. 4A, are known. Given this information, the secondary synchronization sequence can then be identified and processed to yield the location of the frame boundary. Following step 6102, flowchart 6100 proceeds to step 6104.

In step 6104 of the present embodiment, input data is received at a correlator. The input data is the portion of the control channel data 418 of FIG. 4A, which contains secondary synchronization sequences, e.g., Cₛ, 1 408a through C_{s,N} 408n. The input data is received at communication device 100 and communicated in parallel to the appropriate configurable hardware components, e.g., to correlator circuit A 250 and correlator circuit M 260 of FIG. 2C in parallel via line 121. The input data is communicated to as many correlator circuits are available or activated in a given communication device. Following step 6104, flowchart 6100 proceeds to step 6106.

In step 6106 of the present embodiment, a code sequence of a code group is received at the first correlator, as input 6106a. The code sequence is one of the secondary synchronization code sequence defined by FIG. 4B, e.g., sequences 1 through 16. Step 6106 is implemented by receiving a code sequence, e.g., scrambling sequence 1 252-N, from a memory, e.g., memory A 252, at a correlator circuit, e.g., circuit A 250. In an alternative embodiment, the sequence values loaded into memory can be the same values, thus essentially providing a primary sequence searcher, whose code sequences are identical. Following step 6106, flowchart 6100 proceeds to step 6108.

In step 6108 of the present embodiment, the first input data is correlated with the first code sequence using the correlator. Step 6108 is implemented by performing the multiplication and sum functions, known by those skilled in the art, which are appropriate for a correlation operation. In particular, multiply circuit 304 and sum circuit 306 of FIG. 3 perform these functions on the received input data on line 121 and the secondary code sequence 247. A correlation output result 6108a is produced by step 6108. Following step 6108, flowchart 6100 proceeds to step 6110.

In step 6110 of the present embodiment a correlation result from the first correlator is compared with a threshold value using a first threshold detector. Step 6110 is implemented by receiving the output from correlation circuit 240 at a threshold detector, e.g., detector 244 of FIG. 2B via line 241. A threshold input 6110a is provided at a threshold detector for evaluating the correlation result. Input 6110a is implemented by communicating a threshold input 125 to threshold detector 244 as shown in FIG. 2B. Following step 6110, flowchart 6100 proceeds to step 6111.

In step 6111 of the present embodiment, in inquiry determines whether the threshold is satiated. If the threshold is satiated, then flowchart 6100 proceeds to step 6112. However, if the threshold is not satiated, then flowchart 6100 proceeds to step 6114. Step 6111 provides a direction for processing data depending on the correlation results from step 6110. In an alternative embodiment, if the threshold is satiated per step 6111, flowchart 6100 can still proceed to step 6114 to ensure that every possible code sequence is evaluated. For example, if the correlation operation of the second code sequence with the input data satiates the threshold, then the second code sequence is either the correct code sequence or a false alarm. By confirming that the balance of the code sequences do not match the input data, the confidence of the correlation operation is enhanced. Complementally, if more than one code sequence matches a given input data, then the results can be treated as a possible false alarm.

Step 6112 arises if the threshold is satisfied per step 6111. In step 6112 of the present embodiment, the matching code sequence is identified. Logic in local or system controller 226 or 130, respectively, determines what scrambling sequence input from memory, e.g., scrambling sequence N/2 252-N, was provided to the correlator circuit, e.g., correlator circuit A 250, that produced the output from the successful threshold detector, e.g., detector 254. In this manner, the matching code sequence can be identified. Following step 6112, flowchart 6100 proceeds to step 6117.

Step 6114 arises if the threshold was not satisfied per step 6111. In step 6114 of the present embodiment, an inquiry determines if additional code sequences exist. If additional code sequences exist, then flowchart 6100 returns to step 6106. Alternatively, if no additional code sequences exist, then flowchart 6100 proceeds to step 6116. Step 6114 provides the logic to step through all the secondary synchronization code sequences for a given spread spectrum application. For example, FIG. 4B provides a protocol where fifteen entries using any of sixteen possible code sequences are used in a group. Thus, all sixteen hypotheses are tested in the present embodiment for a given input data.

Still referring to step 6114, if additional code sequences do exist, then the present embodiment repeats steps 6104 through 6114 for a new code sequence in a time period that is less than the duration of slot period, e.g., slot 1 403-1 of FIG. 4A. In another embodiment, if only one correlator circuit, e.g., circuit 240, is used in a secondary synchronization channel searcher 222a of FIG. 2B, then all possible secondary code sequences are evaluated in steps 6104 through 6114 in a time period that is less than the duration of slot 1 403-1. The locally scaled clock rate input 232a enables these different embodiments to be realized in configurable searcher 122. If more than one correlator exists, then the hypothesis of secondary synchronization code sequences can be divided amongst the multiple hardware components.

Step 6116 arises if no additional code sequences exist per step 6114. In step 6116, an unsuccessful correlation is indicated. Step 6116 can account for a case where an error in the primary synchronization slot exists, or noise has corrupted data such that results do not satisfy the threshold. This information can be useful to a management algorithm operated on system controller 130 or local controller 226 that controls the synchronization of the control channel, or the sequence of primary and secondary synchronization steps. Following step 6116, flowchart 6100 proceeds to step 6117.

In step 6117 of the present embodiment, the matched code sequence is compared to a sequence of code sequence in multiple code groups to identify a match. Step 6116 can be implemented in local memory 224 and local controller 226 or in system memory A20 and system controller 130. Many different algorithms can be utilized to identify the correct code group to which a series of scrambling sequences in a given communication device correspond. For example, a tree search method can be utilized to identify which code possibilities follow a secondary synchronization of a particular code sequence. As a more specific example, if a communication device starts a secondary synchronization operation at random start location 414 as shown in FIG. 4A, and if a transmitting unit is sending a group 63 code sequence, shown as item 466 in FIG. 4B, then the first successful correlation result will provide a code sequence of 12, shown as item 464 in FIG. 4B. Following step 6117, flowchart 6100 proceeds to step 6118.

In step 6118 of the present embodiment, an inquiry determines if successive matching code sequences correspond to any code groups. If successive matching code sequences do correspond to a single code group, then flowchart 6100 proceeds to step 6120. This case accounts for an unambiguous identification of the correct code group. However if successive matching code sequences do not correspond to a single code group, then flowchart 6100 returns to step 6104. Step 6118 provides the logic to check the code sequence hypothesis, e.g., the sixteen code sequences 1 through 16 of FIG. 4B, for a new slot, e.g., slot C_{s,2} 408b of FIG. 4A. In this manner, successive code sequence matches can be identified.

Successive code sequences are necessary to accurately identify the code group to which a given channel signal is using. For example, without knowing the start location or the group code sequence, the only information available is the fact that the code sequence is 12, for the example of step 6117. And code sequence 12, as item 462, can exist at other locations, e.g., code group 1, item 468, as shown in FIG. 4B. Consequently, a series of matching code sequences obtained from repetitions of portions of flowchart 6100 are compared to known code groups of sequences for a match. By identifying the code group to which a particular order of secondary synchronization sequences belong, the initial secondary synchronization sequence of the group will be known, e.g., the correct code group 63 will eventually be selected.

Step 6120 arises if successive matching code sequences correspond to a code group. In step 6120 of the present embodiment, the matching code group is communicated to the system, thereby enabling the correct synchronization point. That is, once the initial secondary synchronization sequence of a group is known, then the beginning of the frame for the incoming data can be accurately identified. For example, code sequence 9 of FIG. 4B is the start of frame 404 for control channels using code group 63. This process ultimately leads to accurate synchronization and successful communication between two devices. For example, secondary synchronization sequence C_{s,1} 408a of FIG. 4A will be identified and allow the correct portion of a data stream to be demodulated and processed by communication device. Following step 6120, flowchart 6100 ends.

While the present embodiment applies flowcharts 6000 and 6100 to a cellular spread spectrum communication system, the present invention can be applied to an electronic device using a wide range of spread spectrum protocols. Within the cellular spread spectrum communication system described in the present embodiment, the present invention is applicable to mobile units, base stations, and test platforms.

Furthermore, while flowcharts 6000 and 6100 of the present embodiment show a specific sequence and quantity of steps, the present invention is suitable to alternative embodiments. For example, not all the steps provided in the aforementioned flowcharts are required for the present invention. Similarly, other steps may be omitted depending upon the application. In contrast, the present invention is well suited to incorporating additional steps to those presented, as required by an application, or as desired for permutations in the process.

Lastly, the sequence of the steps for flowcharts 6000 and 6100 can be modified depending upon the application. Thus, while the present flowcharts are shown as a single serial process, they can also be implemented as a continuous or parallel process. For example, if a communication device has multiple parallel correlator circuits, e.g., circuit A 250 and circuit M 260, then flowchart 6100 can be applied to both circuits in parallel, e.g., simultaneously. In particular, input data step 6104 would be received in parallel at the multiple correlator circuits. Additionally, code sequences per step 6106 would be received in parallel at the multiple correlator circuits. In this scenario, the secondary synchronization code sequence hypothesis would be divided among the memory resources, e.g., memory A 252 taking the first half of the sequences, 252-1 through 252-N, while memory M 262 would take the second half of the sequences, 262-1 through 262-M. Similarly, codes and input data would be correlated per step 6108 in parallel using the two correlation circuits and would be compared and evaluated per steps 6110 through 6114.

In the present embodiment, each time slot of FIG. 4A is divided into 10 sub-slots, during which two secondary synchronization (short code) group correlations are performed. If sixteen possible code sequences were used in a communication protocol, then 8 sub-slots would cover all possible short code groups (e.g., 16). The remaining 2 sub-slots can be used to prepare for the arrival of the next sequence of the (short) code group.

Many of the instructions for the steps, and the data input and output from the steps, of flowcharts 6000 and 6100 utilize memory and processor hardware components, e.g., system memory A20 and processor 130 in FIG. 1, or local memory 224 and local controller 226 of FIG. 2A. The memory storage used to implement the flowchart steps in the present embodiment can either be permanent, such as read only memory (ROM), or temporary memory such as random access memory (RAM). Memory storage can also be any other type of memory storage, capable of containing program instructions, such as flash memory, etc. Similarly, the processor used to implement the flowchart steps can either be a dedicated controller, an existing system processor, or it can be a dedicated digital signal processor (DSP), as appropriate for the type of step. Alternatively, the instructions may be implemented using some from of a state machine.

Some portions of the detailed description, e.g., the processes, are presented in terms of procedures, logic blocks, processing, and other symbolic representations of operations on data bits within a computer or digital system memory or on signals within a communication device. These descriptions and representations are the means used by those skilled in the digital communication arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a communication device or a processor. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels to be interpreted further in view of terms commonly used in the art. Unless specifically stated otherwise as apparent from the following discussions, it is understood that throughout discussions of the present invention, terms such as “receiving,” “correlating,” “comparing,” “repeating,” “scaling,” “communicating,” “initializing,” “operating,” “storing,” “allocating,” “identifying,” “modifying,” or the like, refer to the action and processes of a communication device or a similar electronic computing device, that manipulates and transforms data. The data is represented as physical (electronic) quantities within the communication devices components, or the computer system's registers and memories, and is transformed into other data similarly represented as physical quantities within the communication device components, or computer system memories or registers, or other such information storage, transmission or display devices.

In view of the embodiments described herein, the present invention provides a solution to the limitations associated with the varied hardware, software, and methodology of synchronizing digital signals for each of the varied spread spectrum applications. Additionally, the present description illustrates how the present invention overcomes the lack of backward and forward compatibility associated with new generations of synchronization protocols, hardware, and infrastructure within any of the varied wireless applications. Lastly, it has been shown how the present invention provides a method and apparatus to synchronize multiple code sequences with input data while overcoming the limitations of inefficient and slow hardware and software algorithms.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

I claim:

1. A method of correlating multiple code groups against input data, the method comprising the steps of:
a) receiving a first input data at a first correlator;
b) receiving a first code sequence of a code group at the first correlator;
c) correlating the first input data with the first code sequence using the correlator;
d) receiving a second code sequence at the first correlator;
e) correlating the first input data with the second code sequence using the first correlator, wherein correlating step e) is performed prior to receiving a second input data; and
f) comparing a correlation result from the first correlator with a threshold value using a first threshold detector.

2. The method recited in claim 1 wherein the first input data and the second input data are synchronization sequence inputs, and wherein the first code sequence and the second code sequence are locally stored scrambling sequences.

3. The method recited in claim 1 further comprising the steps of:
g) receiving in parallel the first input data at a second correlator with respect to the first correlator;
h) receiving a third code sequence at the second correlator;
i) correlating in parallel the first input data with the third code sequence using the second correlator, with respect to the first correlator; and
j) comparing a correlation result from the second correlator with the threshold value using a second threshold detector.

4. The method recited in claim 3 further comprising the steps of:
k) receiving a fourth code sequence at the second correlator; and
l) correlating the first input data with the fourth code sequence using the second correlator, wherein correlating step k) is performed prior to receiving the second input data.

5. The method recited in claim 1 further comprising the steps:
g) repeating steps a) through f) for additional code sequences as defined by a communication protocol.

6. The method recited in claim 4 further comprising the step of:
m) repeating steps a) through l) for additional code sequences as defined by a communication protocol.

7. The method recited in claim 1 further comprising the step of:
g) receiving configuration information at the first correlator.

8. The method recited in claim 1 further comprising the step of:
g) scaling a system clock rate into a local clock rate, wherein the local clock rate ranges from a slot period to a fraction of the slot period.

9. A method for configuring a configurable searcher, the method comprising the steps of:
a) receiving a code group configuration input at a communication device.
b) communicating the code group configuration to the configurable searcher;
c) initializing the configurable searcher according to the code group configuration; and
d) operating the configurable searcher according to the code group configuration.

10. The method recited in claim 9 further comprising the steps of:
e) storing the code group configuration in memory.

11. The method recited in claim 9 wherein the code group configuration input specifies a quantity of groups of codes, an order of code sequences within each group, or the sequence values.

12. The method recited in claim 11 further comprising the step of:
e) allocating a sufficient memory to accommodate the quantity of code groups and a length of the sequences used in code groups.

13. The method recited in claim 9 further comprising the step of:
e) receiving a local clock rate input at which the configurable searcher is to operate; and

14. The method recited in claim 9 further comprising the step of:
e) identifying a quantity of correlators necessary for accommodating a code group configuration.

15. The method recited in claim 9 further comprising the step of:
e) modifying a system clock rate at a local controller to match a local clock rate input.

16. The method recited in claim 13 further comprising the step of:
f) operating the configurable searcher according to the code group configuration and the local clock rate input.

17. A searcher for data processing, the searcher comprising:
a first input line for communicating input data;
a second input line for communicating a first set of code sequences;
a first correlator coupled to the first input line and the second input line, the first correlator circuit capable of completing a correlation operation within a fraction of a slot period; and
a first threshold detector coupled to the first correlator, the first threshold detector receiving a threshold input and a correlation result from the first correlator.

18. The searcher recited in claim 17 further comprising:
a first memory coupled to the second input line, the first memory storing the first set of code sequences.

19. The searcher recited in claim 17 further comprising:
a third input line for communicating a second set of code sequences;
a second correlator coupled to the first input line in parallel to the first correlator, wherein the second correlator coupled to the third input line, and wherein the second correlator is capable of completing a correlation operation within the fraction of the slot period;
a second threshold detector coupled to the second correlator, the second threshold detector receiving the threshold input and a correlation result from the second correlator.

20. The searcher recited in claim 19 further comprising:
a second memory coupled to the third input line, the second memory storing the second set of code sequences.

21. The searcher recited in claim 19 further comprising:
a local controller capable of scaling a system clock rate into a local clock rate that ranges from the slot period to the fraction of the slot period.

22. A communication device for processing a data signal, the communication device comprising:
a front-end processor for communicating the data signal;
a processor coupled to the front-end processor and a modem;
a system memory coupled to the processor;
a configurable searcher system coupled to the processor, the configurable searcher system using a code group configuration dictated by a desired one of a plurality of communication protocols; and
wherein the processor and the system memory provide configuration information to the configurable searcher system.

23. The communication device recited in claim 22 wherein the configurable searcher system comprises:
a configurable searcher;
a local memory coupled to the configurable searcher, the local memory capable of storing the configuration information.

24. The communication device recited in claim 23 wherein the configurable searcher system further comprises:
a local controller coupled to the local memory and to the configurable searcher, the local controller scaling a system clock rate to match a local clock rate.
